(19) United States
(12) Patent Application Publication
(10) Pub. No.: US 2017/0070711 A1
(43) Pub. Date: Mar. 9, 2017

(54) INTENSITY CORRECTION FOR PROJECTION SYSTEMS

(71) Applicant: Disney Enterprises, Inc., Burbank, CA (US)

(72) Inventors: Anselm Grundhofer, Greifensee (CH); David Robert Wyatt Rose, Glendale, CA (US)

(21) Appl. No.: 14/844,165

(22) Filed: Sep. 3, 2015

(51) Int. Cl. H04N 9/31

(52) U.S. Cl. CPC H04N 9/3147; H04N 9/31; H04N 9/317; H04N 9/3185

(57) ABSTRACT

The present disclosure is generally related to a method for intensity correction for multiple projector systems. In one method, the intensity blending maps are created. The method includes generating a plurality of pixel maps for a plurality of projectors based on at least one of an orientation of the plurality of projectors and a projection surface and adjusting an intensity of at least one pixel of at least one of the plurality of projectors based, at least in part, on the plurality of pixel maps.

### FIELD

This disclosure relates generally to multiple projector systems and more particularly to generating pixel intensity blending maps for multiple projector systems.

### BACKGROUND

Multiple projector systems (i.e., projection systems using two or more projectors) are typical in applications with large projection surfaces. By utilizing multiple projectors, the spatial resolution of the projected image can be increased because each projector provides a portion of the total projected image on a portion of the total projection surface. That is, each projector projects only a fraction of the entire projected image and the composite of the projected images defines the whole projected image. Additionally, multiple projector systems allow images to be projected onto three-dimensional (3D) surfaces where light from a single projector may be blocked by the shape of the surface and may not reach all desired locations.

In multiple projector systems, such as the ones described above, the projected image from one projector often overlaps with the projected image of neighboring projectors in order to provide a continuous projected image on the projection surface. Overlapping regions thus receive light from more than one projector, increasing the intensity of light on the overlapping region and leading to noticeable and often distracting light intensity variations for a viewer, as well as changing the visual output from a desired light intensity and/or color. Additionally, traditional projectors are typically unable to completely eliminate light when projecting black images and light leakage can occur. In overlapping regions, this light leakage compounds with the inadvertent increased intensity to create perceptibly lighter regions. Compensation techniques for these issues are often complicated by the size and shape of the projection surface. If the projection surface is three-dimensional, for example, certain contours or objects can skew images, cast shadows, or otherwise distort the projected images.

### SUMMARY

In one embodiment, a method of blending pixel intensity is provided. The method includes generating a plurality of pixel maps for a plurality of projectors based on at least one of an orientation of the plurality of projectors and a projection surface and adjusting an intensity of at least one pixel of at least one of the plurality of projectors based, at least in part, on the plurality of pixel maps.

In another embodiment, a method of generating a substantially seamless image with a plurality of overlapping projection images is provided. The method includes projecting, with a first projector, a first structured light pattern on a projection surface. The method further includes receiving, by a processor, a first image corresponding to the first structured light pattern. The method further includes projecting, with a second projector, a second structured light pattern on the projection surface, wherein the second structured light pattern at least partially overlaps the first structured light pattern on the projection surface. The method further includes receiving, by a processor, a second image corresponding to the second structured light pattern. The method further includes generating, a set of pixel correspondences between the first projector and second projector, based on the first image and the second image and modifying a brightness of one or more pixels of at least one of the first and second projector based, at least in part, on the set of pixel correspondences.

In yet another embodiment, a system for generating pixel intensity blending maps is provided. The system includes a plurality of projectors that project at least partially overlapping projection regions onto a projection surface, a processor, and a computer readable storage device having program instructions stored thereon for execution by the processor. The program instructions include program instructions to project, by the plurality of projectors, structured light patterns on the projection surface. The program instructions further include program instructions to receive data corresponding to images of the structured light patterns. The program instructions further include program instructions to generate a plurality of correspondence tables based on the images, the plurality of correspondence tables describing which projectors of the plurality of projectors can emit light on each point of the projection surface. The program instructions further include program instructions to generate a plurality of pixel maps for each of the plurality of the projectors, the pixel maps including overlapping projection region information. The program instructions further include program instructions to adjust an intensity of one or more pixels based on the pixel maps to generate a composite image having a perceptibly smooth intensity.

### BRIEF DESCRIPTION OF THE DRAWINGS

FIG. 1A is a diagram of a projector system projecting onto a projection surface.

FIG. 1B is a diagram of the projector system of FIG. 1A projecting onto a 3D projection surface.

FIG. 2 is a flowchart illustrating a method of generating a pixel intensity blending map for overlapping projection regions of the projection surface.

FIG. 3A is a front elevation view of a first example of a structured light pattern projected onto the projection surface.

FIG. 3B is a front elevation view of a second example of a structured light pattern projected onto the projection surface.

FIG. 4A is a front elevation view of the projection surface illustrating projection regions with an overlapping region.

FIG. 4B is a front elevation view of the individual projection regions of FIG. 4A.

FIG. 4C is a front elevation view of the projection surface illustrating the projection regions of FIG. 4A.

FIG. 5 is a flowchart illustrating a method of generating a black level intensity blending map.

FIG. 6 is a block diagram illustrating various operations of the methods of FIGS. 2 and 5 for creating compensation images in a multiple projector system.

FIG. 7 is a functional block diagram of exemplary components of the projectors of FIG. 1.

FIG. 8 is a functional block diagram of exemplary components of the computer of FIG. 1.

### SPECIFICATION

### Overview

The present disclosure provides methods and systems for compensating and correcting projected images creating a composite image in a multiple projector system. In one embodiment, a virtual representation of a projection system is generated. The virtual representation of the projection system can include 3D aspects of a projection surface such as surface geometry or 3D objects in the projection path. Using the virtual representation, pixel intensity blending maps indicating overlapping projections regions are calculated for each pair of projectors in the projection system. The term pixel as used herein encompasses both the points constituting an image on the projection surface (e.g., points on the 3D surface), as well as the picture elements of a respective imaging device, such as a camera or projector.

The pixel intensity blending maps for overlapping regions, also referred to herein as alpha blending maps, account for arbitrary diffuse surfaces and are used to modify the originally input images to compensate for the overlapping regions and projector characteristics. Once the blending maps are generated for the virtual projector system, additional processing accounts for various physical phenomena or physical characteristics (e.g., geometrical orientations of the projection system, characteristics of the projection surface or the projector, and so on). The intensity blending maps can then be applied to inputted projected images to generate a resulting projected image visually smooth such that overlapping regions are not visible to the viewer. Then, the light intensity of one or more pixels of the projectors is adjusted based on overlapping sections of images projected by one or more projectors, as well as light leakage and other intrinsic characteristics of each projector to create one or more compensated images.

Additionally, black level compensation maps, also referred to herein as beta blending maps, can be generated that assist in compensating for projector characteristics, such as light leakage. A region of the projection surface having a maximum number of projectors contributing light to the region is determined. The maximum overlapping region is determined based on overlap maps designating which projectors contribute to each pixel of the projection surface. Using the overlap maps, black level compensation maps can be generated that indicate how much the pixel intensity of each region on the projection surface should be increased to match the intensity of the maximum overlapping region. The projection image can be modified, for example, by increasing the intensity to non-overlapping regions, to compensate for the intrinsic features of the projector, reducing visible artifacts due to light leakage from the projector. The light leakage results in an increased black level intensity in overlapping regions that can be adjusted for in non-overlapping regions by increasing the projected pixel intensity.

Both the intensity blending maps the black level compensation maps can be used on their own or together, depending on the desired level of correction. Using both maps together creates compensated images having a substantially uniform intensity and light levels across the overlapping and non-overlapping regions of the projected composite image. As used herein, “substantially smooth” or “substantially seamless” refers to a projected image where any pixel intensity variations caused by overlapping projectors are imperceptible to a viewer.

### DETAILED DESCRIPTION

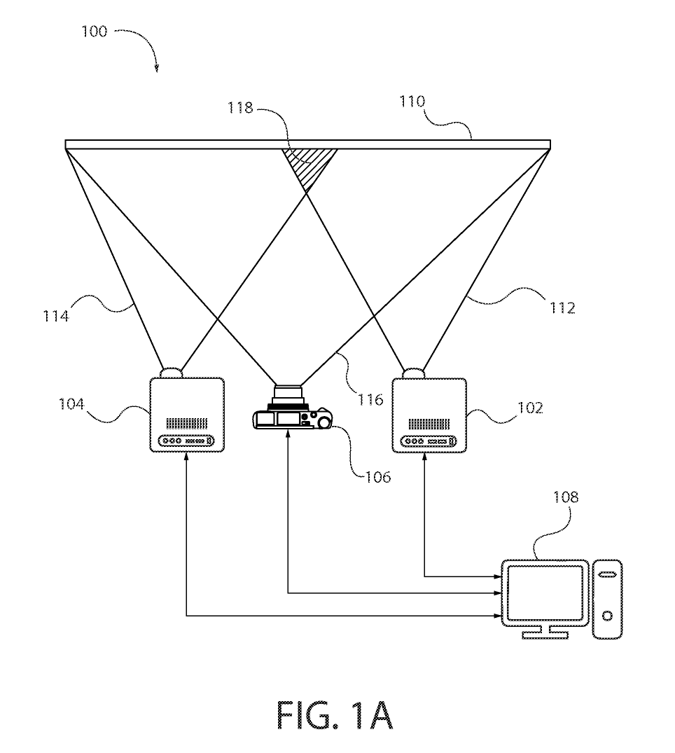

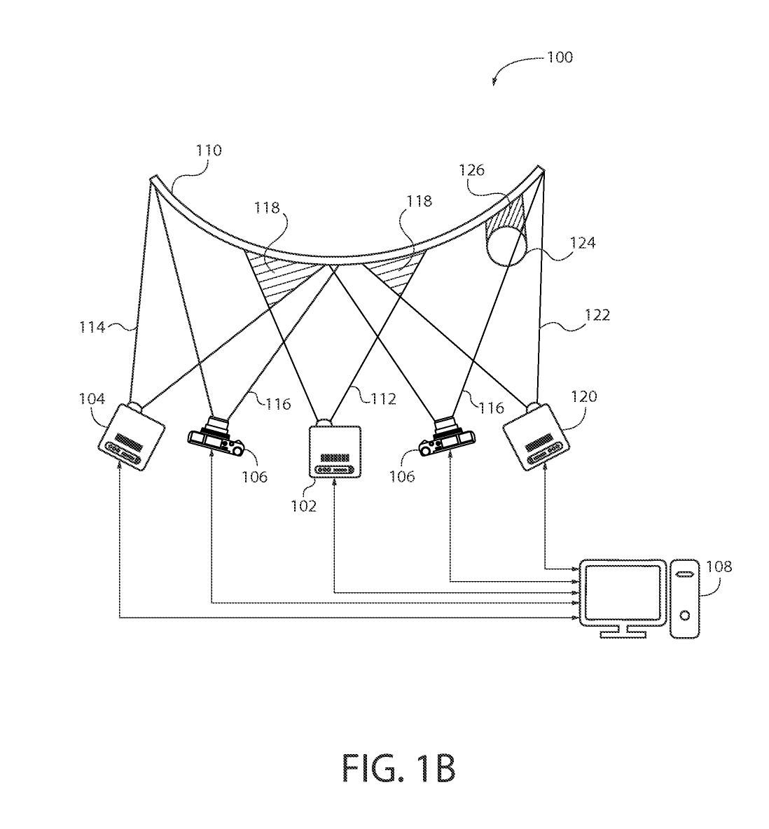

Turning to the figures, a projection system will now be discussed in more detail. FIGS. 1A and 1B are functional block diagrams of the projection system, generally designated 100. The projection system 100 includes one or more projectors 102, 104, a camera 106, a computer 108, and a projection surface 110. Although only two projectors 102, 104 and one camera 106 are illustrated in FIG. 1A, the projection system 100 can include substantially any number of each respective device 102, 104, and 106 as desired. For example, FIG. 1B show the projection system 100 further including a third projector 120 and a second camera 106. The projectors 102, 104 include fields of view (FOVs) 112, 114 directed toward the projection surface 110 and that allow the projectors 102, 104 to project images onto a region on the projection surface 110. The FOVs 112, 114 overlap on the projection surface at an overlap region 118. In the embodiment of FIG. 1B, the third projector 120 includes an FOV 122 that overlaps with the FOV 112 of the projector 102.

The camera 106 includes FOV 116. The FOV 116 allows the camera 106 to capture one or more images of the complete projection surface 110, including the overlapping region 118. The camera 106 is used to capture images of the entire projection surface 110. In some embodiments, multiple cameras can be used to ensure that the entire projection surface 110 is captured. Capturing images of the entire projection surface 110 provides correspondence information between pixels projected by the projectors 102, 104, pixels as they appear on the projection surface 110, and pixels captured by the camera 106. Using the pixel correspondence information, blending maps can be generated to compensate for projection image overlap, light leakage from the projectors, and other undesirable effects in projected images. In various embodiments, the projectors 102,104 and the camera 106 can be arranged in any configuration so long as the configuration is known or can be determined. For example, the camera 106 can be positioned between the projectors 102, 104, as shown in FIG. 1. Alternatively, the camera can be placed at the location of one of the projectors 102 or 104. The above examples are only two potential configurations, and the positions of the projectors 102, 104 and the camera 106 can be otherwise varied.

The projection surface 110 is substantially any type of surface. In many instances the projection surface 110 may be a textured, off-white, colored, or other non-ideal reflective projection surface. The projection surface 110 can be a substantially planar or an arbitrarily shaped surface, as shown in FIG. 1A, with sufficient diffuse reflectance to form an image in a given environment. In another embodiment, the projection surface 110 may be an amorphous or curved surface, as shown in FIG. 1B, such as a dome or arced projection surface 110. Further, the projection surface 110 may include various physical features that, when an image is projected onto the projection surface 110, casts shadows or otherwise distorts, blocks, or obfuscates the projected image. For example, in the embodiment of FIG. 1B, an obstruction 124 casts a shadow 126 onto the arced projection surface 110. Light emitted by the projector 120 is blocked by the obstruction 124, which prevents it from reaching the projection surface 126. Such obstructions, as well as the topography of the projection surface 110 distort the projected image. Compensation techniques, such as those described herein, can correct for the distortions to provide a visually consistent image. It should be noted that the projection surface 110 can be white and may not include much, if any, spatially varying or arbitrary surface reflectance (i.e., be relatively smooth), but in these instances the images from the projector may not require a substantial amount of compensation. In other words, the methods and system disclosed herein typically will have a more obvious effect in compensating projection images that are projected onto non-ideal surfaces. Additionally, the methods and system disclosed herein may be used for projectors that use rear projection. In these instances, the rear projection surface may be transmissive with sufficient diffusivity to allow an image to be formed.

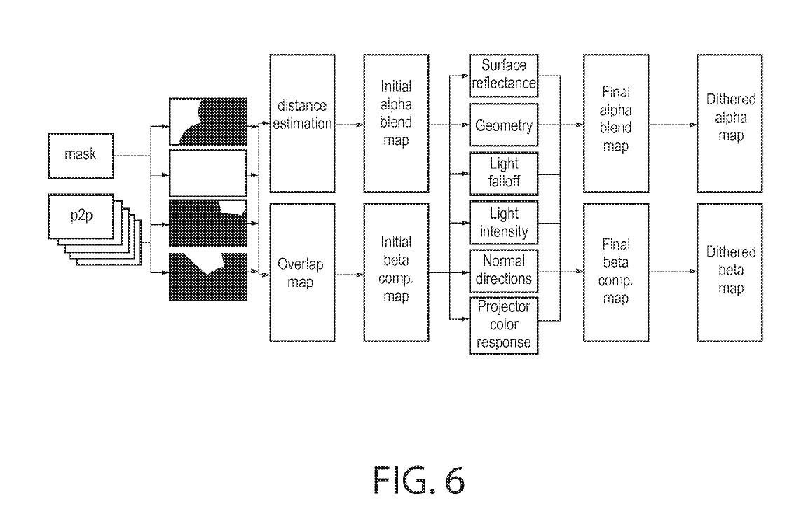

The projectors 102,104 are devices configured to project and spatially control light onto a surface and may emit light in a color space, such as red, green, blue and alpha (RGBA). In some examples, the projectors 102, 104 can be digital light processing (DLP) projectors. The projectors 102, 104 are configured to project images onto the projection surface 110 such that the projected images overlap by a number of pixels in the overlapping region 118. The intensities of light emitted by the projectors 102, 104 can be adjusted, for example, on a pixel-by-pixel basis. For example, the projectors 102, 104 can selectively increase or decrease light intensity for each pixel generated by the projector 102, 104. Exemplary components of the projectors 102, 104 are described in further detail below with respect to FIG. 6. In addition to projecting light onto the projection surface 110, the projectors 102, 104 may be in electrical communication with the computer 108 via wireless or wired manners.

The camera 104 is in optical communication with the projection surface 110 and is any device configured to capture images. The camera 106 typically includes a lens and an image sensor, such as a charge-coupled device, a complementary metal-oxide-semiconductor device, or an N-type or P-type metal-oxide-semiconductor. The type of image sensor and lens are typically varied based on the camera. In many examples the camera 106 is configured to capture color images; however, in other embodiments the camera may be monochromatic and one or more color filers can be used over the camera's lens to capture color images. It is desirable for the image sensor of the camera 106 to be able to capture the entire dynamic range of the projected light intensities to allow better correction of the projected images, but is not always necessary. The camera 106 captures one or more images of structured light patterns projected onto the projection surface 110 by the projectors 102, 104. The correction images can be used to correct and modify images projected by the projection system 100. The camera 104 may be in electrical communication with the computer 108 directly (e.g., via cable, WiFi or other wireless data transmission method) or indirectly (e.g., removable memory card, etc.) and transfers the correction images of the structured light patterns to the computer 108.

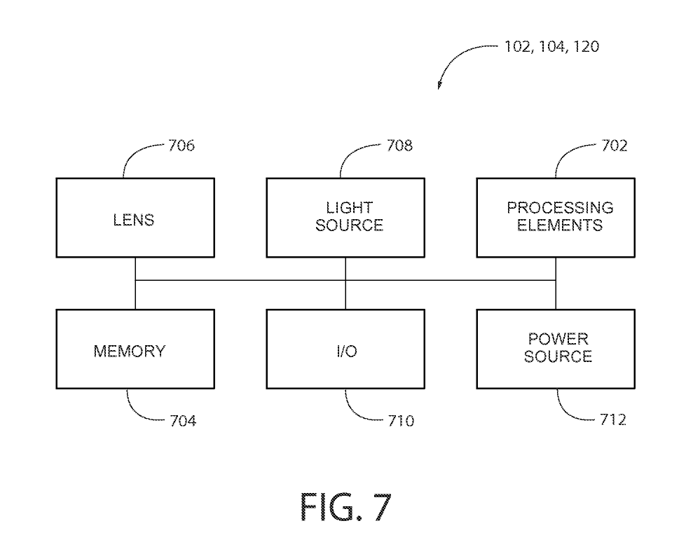

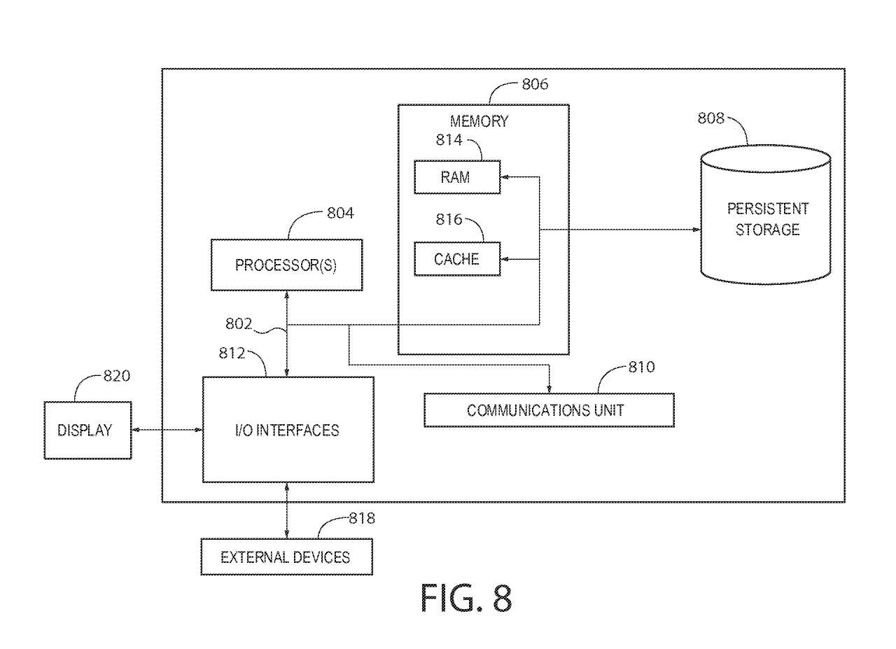

The computer 108 may communicate with and control the projectors 102, 104 and the camera 106. In certain embodiments, the computer 108 calculates pixel intensity blending maps and communicates with the projectors 102, 104 to adjust the intensity of projected images based on the pixel intensity blending maps. The computer 108 can be a server computer, a laptop computer, a tablet computer, a netbook computer, a personal computer, a smartphone, or a desktop computer. In another embodiment, the computer 108 can represent a computing system utilizing clustered computers and components to act as a single pool of seamless resources, as is common in “cloud computing.” In general, the computer 108 can be any programmable electronic device capable of communicating with the other devices in the projection system 100. The computer 108 can include internal and external components, as depicted and described in further detail with respect to FIG. 7.

The projectors 102, 104 direct light toward the projection surface 110. In the embodiment of FIGS. 1A and 1B, the projectors 102, 104 direct light to the overlapping region 118. Accordingly, before correction, the overlapping region 118 appears more intense than non-overlapping regions of FOVs 112 and 114 due to the additive effects of the projected intensities. In this manner, before correction, the overlapping region 118 will have an output image appearance that varies from the desired output image of the projection system 100.

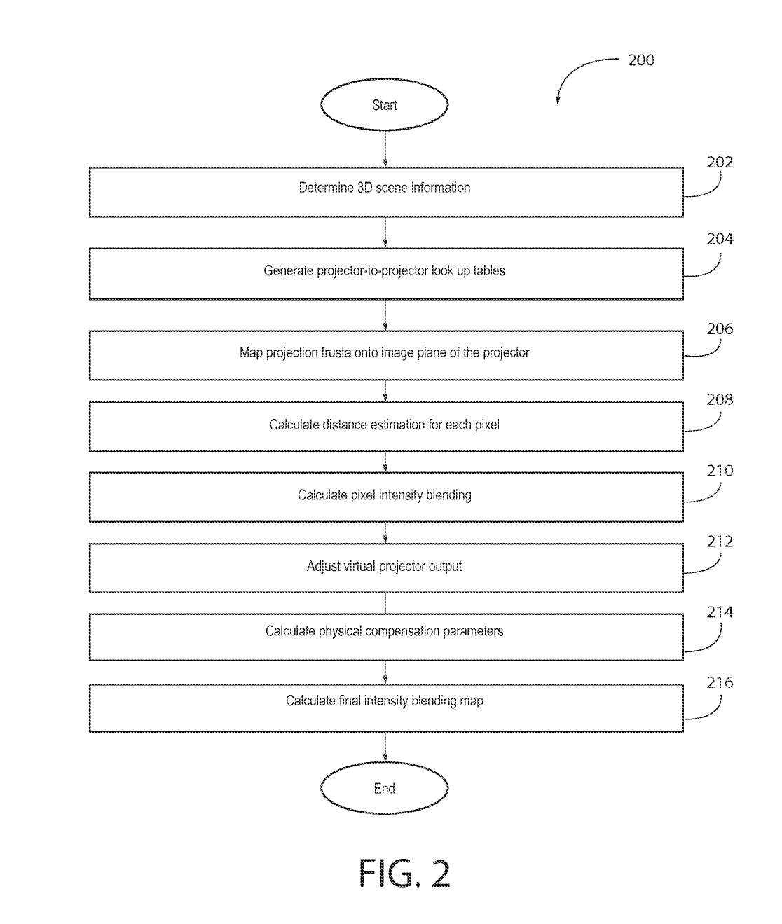

To compensate for the increased intensity in the overlapping region 118, a pixel intensity blending map can be calculated and applied to the projectors 102, 104 to adjust the intensity to account for this effect. FIG. 2 is a flowchart illustrating a method 200 of generating a pixel intensity blending map. The operations of the method 200 can be performed, in whole or in part, by the computer 108 of FIG. 1. However, other devices or components can perform some or all of the operations of the method 200 according to various alternative embodiments. In operation 202, the computer 108, typically a processor of the computer 108, determines the 3D scene information. The 3D scene information includes, for example, the spatial location and orientation of the projectors 102, 104 and the camera 106 to each other, as well as the surface geometry of the projection surface 110. The orientation of the projectors in space can be manually measured or can be determined automatically using known techniques such as a calibration via automatically generated 2D to 3D correspondences, calibration using multi-view self-calibration, etc.

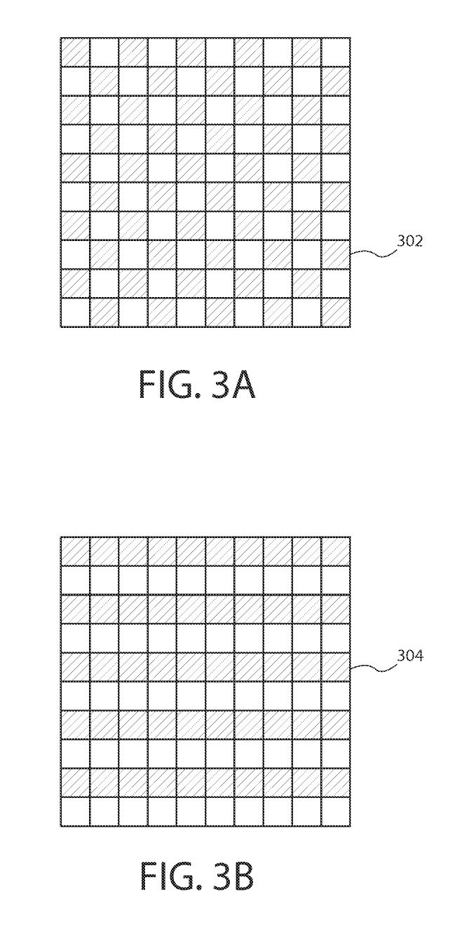

The camera 106 may be calibrated using, for example, a planar marker, e.g. a checkerboard, calibration technique or a full self-calibration technique. In embodiments using a planar marker calibration technique, a planar surface with known feature points, such as a checkerboard on it is placed within the viewing frustum of the camera 106. The camera 106 captures one or more images of the planar surface which is moved to different locations to determine pixel correspondences between the pixels of the camera 106 and the known feature locations on the pattern. Based on the known pattern in the planar marker the camera's 106 orientation and lens properties are calibrated. Images captured by the camera 106 of the projected structured light pattern are then used to create a dense set of sub-pixel accurate correspondences between the pixels of the camera 106 to the pixels of each of the projectors 102, 104. The set of pixel correspondences can be stored as look up tables that provide pixel correspondences from the camera 106 to each projector 102, 104 (camera-to-projector look up tables) and from each projector 102, 104 to the camera 106 (projector-to-camera look up tables). That is, each pixel of the structured light pattern projected by the projectors 102, 104 can be located in a corresponding pixel of the camera 106. These pixel-to-pixel correspondences can be saved as look up tables such that identifying a particular pixel of the projected image provides the corresponding pixel of the camera, and vice versa. Example structured light patterns are described in more detail below with respect to FIGS. 3A and 3B. Additional adjustments to the calibration can account for any applicable lens effects, such as aberrations, of the projectors 102, 104.

In embodiments using a self-calibration or auto calibration technique, the correspondences between the camera and one or more of the projectors may be determined simultaneously. That is, un-calibrated cameras may be used and the calibration process calibrates the cameras and the projectors in a single step. While this calibration technique reduces the number of calibrations and manual interventions needed, it may also result in a less accurate calibration since depending on the setup this method might not be as robust as another calibration method.

To determine the surface geometry (i.e., the topography) of the projection surface 110, one or more calibration images, such as known projected structured light patterns, can be captured with the calibrated camera 106 and analyzed. For example, the surface geometry can be reconstructed in a virtual world by using structured light patterns projected by the projectors 102, 104. In some embodiments, the surface geometry is reconstructed using binary encoded 2D pixel coordinate indices as structured light patterns. In other embodiments, other types of structured light patterns can be used. Generally, using this method a series of known structured light patterns, such as gray codes and binary blobs, are projected by the projectors 102, 104 onto the projection surface 110 Images of the projected structured light patterns can be captured by the camera 106. The captured images can be analyzed and compared to the known structured light patterns to detect any shadows, obstructions, or deformations caused by the surface geometry of the projection surface 110. Based on the deformations between the structured light patterns and the captured images, a virtual model of the surface geometry can be calculated that matches the physical surface geometry of the projection surface 110 using multi-view reconstruction, for example. To increase the accuracy of the reconstructed surface geometry, the number of structured light patterns and the number of cameras 106 can be increased to capture deformations in the projected structured light patterns more accurately from multiple angles. Having reconstructed the surface geometry, the projectors' orientation and internal parameters such as lens properties can be calibrated.

Turning to FIGS. 3A and 3B, example structured light patterns that can be used as calibration images to derive pixel correspondences will now be described in greater detail. FIGS. 3A and 3B illustrate examples of calibration images. With reference to FIG. 3A, a first calibration image 302 includes a first pattern and with reference to FIG. 3B a second calibration image 304 includes a second pattern. The two patterns of the calibration images 302,304 may be created by varying the colors, intensities, hues, shapes, or the like. For example, the first calibration image 302 includes a checkerboard pattern while the second calibration image 304 includes a horizontal stripe pattern. In these two examples, the patterns are created by altering colors in a pattern, however many other types of patterns may be used. In particular, the two calibration images 302 and 304 are substantially any type of structured light variation that can be used to estimate pixel or sub-pixel accurate correspondences between projector and camera pixels and to estimate, from the correspondences, the surface geometry of the projection surface 110. The number of calibration images and the types of patterns can be varied as desired.

In addition to the above examples, other methods may be used to assess the 3D scene information of the projection surface 110. For example, one or more depth cameras can be used on their own to map the projection surface 110 and its various features. Another example includes the using a laser scanning device to acquire the surface geometry or using a computer generated model which accurately matches the real surface.

The structured light patterns can also be used to determine correspondences between the two dimensional pixels of the projected image, and the corresponding location of those pixels on the 3D projection surface 110. The value and location of each pixel in the two-dimensional (2D) structured light pattern is known. The cameras 106 capture images of the deformed structured light patterns on the 3D projection surface 110. The pixels of the captured images can be compared with the pixels of the structured light pattern, in combination with the determined surface geometry of the projection surface 110 to determine the location of each projected pixel on the 3D projection surface. Determining projector to projection surface pixel correspondences can be used to verify and improve the projector-to-projector look up tables generated using the projector-to-camera lookup tables and the camera-to-projector look up tables as described above with respect to operation 202.

Returning again to the method 200 of FIG. 2, in operation 204, the computer 108 generates projector-to-projector look up tables. The projector-to-projector lookup tables describe the relationship of pixels of each projector with respect to the pixels of the other projectors. These tables are used to illustrate the pixels of an image that are projected by two or more projectors (i.e., overlapping pixels in a particular image). In other words, pixels on the projection surface 110 receiving light from two or more projectors The projector-to-projector look up tables can be generated, for example, by comparing the projector-to-camera look up tables and/or the camera-to-projector look up tables for two projectors (e.g., projectors 102, 104) to one another to determine which pixels of the camera 106 are projected to by both the projectors 102, 104. Another possible means of generating the projector-to-projector look up tables is the usage of the virtual representation of the scene geometry as well as the known calibrated projector orientations and lens properties to calculate which pixels of each projector are projected onto another projector.

The projector-to-projector lookup tables correspond to initial pixel overlap maps for each combination of projectors. For example, in the embodiment of FIG. 1, there are four projector-to-projector look up tables, and therefore four corresponding pixel overlap maps are produced: projector 102 to projector 102, projector 102 to projector 104, projector 104 to projector 102, and projector 104 to projector 104. In another embodiment with four projectors, a total of sixteen projector-to-projector look up tables and corresponding pixel overlap maps are created. In various embodiments, virtual pixel masks can also be applied to the projector-to-projector look up tables. For example, in an embodiment where a 3D feature blocks a portion of a projected image onto the projection surface 110 from one projector, selected pixels from the projected image may be excluded from a projector-to-projector lookup table for another projector. In general, the pixel masks allow certain pixels to be omitted from pixel intensity blending maps, thus preventing the blocked pixels from being adjusted according to the pixel blending function, as described below. This allows a reduction in computing time as the masked pixels do not need to be included in any calculations of the pixel intensity blending maps or the pixel blending functions. The projector-to-projector lookup tables may optionally include an identity lookup table, which includes the pixels of a projector compared to itself. Calculating identity lookup tables can be useful in embodiments, where physical or virtual pixel masks are used to remove certain pixels from a projected image. In these embodiments, the look up table of a projector compared to itself can result in simpler and faster calculations of identity pixel maps because the identity combinations of projectors do not need to be excluded from the calculation.

In operation 206, the computer 108 maps or warps the projection frustum of each projector onto the image plane of each projector for which pixel intensity blending maps are being generated. For example, in the embodiment of FIG. 1A, projector 102 has a projection frustum defined by the FOV 112 and includes all of the pixels projected by the projector 102. The computer 108 generates an initial overlap map for each projector-to-projector combination. The initial overlap map is created on a pixel-by-pixel basis using the projector-to-projector lookup tables.

Specifically, each pixel of the first projector 102 is identified in the projector-to-projector lookup table. If a pixel of the first projector 102 corresponds to a pixel (i.e., both projectors can project to the pixel) of a second projector (e.g., projector 104), then the pixel is indicated as overlapping in the initial pixel intensity blending map. Alternatively, if the pixel of the first projector 102 does not correspond to a pixel of the second projector 104, then the pixel is indicated as not overlapping in the initial pixel intensity blending map. As described above, an initial pixel intensity blending map can be generated for each projector to projector combination (including a projector compared to itself). Optionally, one or more virtual pixel masks can be applied to the initial pixel intensity blending maps to exclude certain pixels from the maps. The masks may be used, for example, to exclude certain pixels that are blocked by a 3D feature from being projected onto by one or more of the projectors 102, 104. Additionally, the masks may eliminate pixels which are outside of an area of interest, such as pixels that are projected off of the projection surface 110.

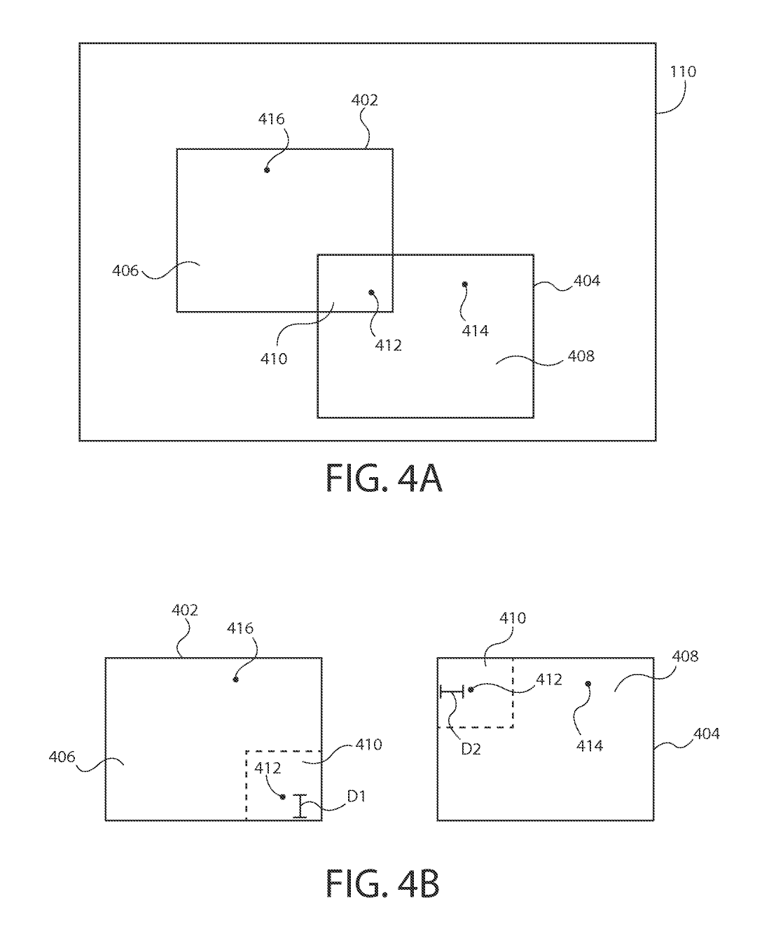

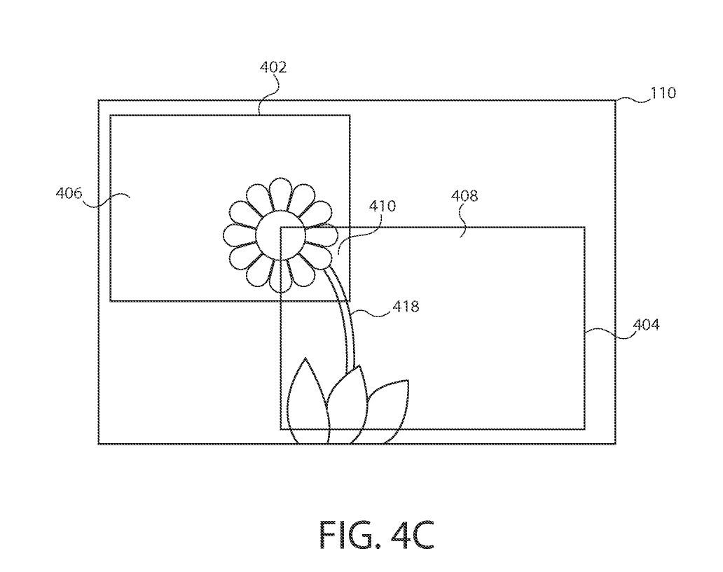

Turning to FIGS. 4A-4C, examples of pixel overlap maps of two projected images of a composite projected image, such as those generated in operations 204 and 206 of the method 200, will now be described. With respect to FIG. 4A a front elevation view of two projection regions of a composited projection image having an overlapping area is shown on the projection surface 110. The projection regions 402, 404 represent specific regions of the projection surface 110 onto which the projectors 102, 104 project, respectively. That is, the first projection region 402 indicates the area of the projection surface 110 that the first projector 102 projects onto and the second projection region 404 indicates the projection area of the second projector 104 with the combination of images from both projectors 102, 104 being used to create a portion of the output composite image 418, shown in FIG. 4C.

The first projection region 402 includes a first non-overlapping region 406 and a first overlapping region 410. Similarly, the second projection region 404 includes a non-overlapping region 408 and the overlapping region 410. Notably, both of the first and second projection regions 402,404 include the overlapping region 410, meaning that each of the projectors generating the projection regions 402 and 404 can project images to the overlapping region 410. For example, the pixel 412 located in the overlapping region 410 can be projected to by both of the projectors 102, 104. However, the pixel 414 can only be projected to by the projector 104.

Returning again to the method 200 of FIG. 2, in operation 208, the computer 108 calculates a distance estimation for each pixel in the overlapping region 410 for each projection region 402 and 404. The distance estimation can be a measure of the shortest distance from a given pixel to a boundary of a given projection region. The boundary can be, for example, an edge of the projection region, the edge of an area of the projection region covered by a pixel mask, the edge of an image plane, or an edge of shadow/occlusion. The distance estimation can be measured, for example, in pixels (e.g., pixel coordinates) or may be measured in other units. The distance estimation can be calculated using a distance transform, such as the Euclidean distance, the Manhattan distance, or the Chebyshev distance. The distance estimation can be made with reference to a particular pixel in the warped pixel overlap maps generated in operation 206. For each pixel in an overlapping region of two or more projectors, the computer 108 can determine the shortest distance between the selected pixel and boundary of each projection region.

With reference again to FIG. 4B, the individual projection regions 402, 404 are shown with the overlapped pixel 412 being in the overlapping region 410 (i.e., projected by both projectors 102, 104). A distance estimation is determined for each of the projection regions 402, 404, as described above with respect to operation 208 of the method 200. With respect to the projection region 402, the overlapped pixel 412 is a distance D1, from the boundary of the projection region 402. Distance D1 may be a pixel number, e.g., 50 pixels, or may be another measurement type or value. With respect to the projection region 404, the overlapped pixel 412 in the overlapping region 410 is a distance D2, from the boundary of the projection region 404. Distance D2 is similar to D1, but varies based on the location of the pixel in this projection region. In one example may be 100 pixels. Accordingly, the overlapped pixel 412 is nearer to the boundary of the projection region 402 than to the boundary of the projection region 404. The distances D1 and D2 represent the distance estimations generated by the computer 108 in operation 208.

Referring again to FIG. 2, in operation 210, the computer 108 calculates the pixel intensity blending for the pixels in the overlapping region 410, e.g., overlapped pixel 412 in FIGS. 4A and 4B. The pixel intensity blending is calculated for the pixels in the overlapping region for each projection region based on the distance estimations (e.g., Distance D1 and D2) generated in operation 208, as well as the number of projectors contributing to the overlapping region. Pixel intensity blending can be calculated using any appropriate blending technique. For example, a linear blending technique can be used so that as pixels approach a boundary of a projection region, the intensity of each pixel decreases in a linear fashion. In one embodiment, the intensity can be adjusted for each pixel by adjusting an alpha value for that each projected pixel. The alpha value corresponds to the transparency of the projected pixel which, when projected, translates to an intensity. For example, the alpha value of a selected pixel can be calculated as the distance estimation for the selected pixel divided by the sum of all distance estimations. In various embodiments, the blending functions are selected such that the total intensity at any one pixel in an overlapping region (i.e., the sum of the intensities of each projector projecting that pixel) is substantially equal to the intensities of the pixels in the non-overlapping regions. That is, in operation 210, the specific contributions of each projector to a particular location on the projection surface 110 is calculated. By calculating and applying the pixel intensity blending functions to each pixel in the overlapping regions, a pixel intensity blending map is generated for each projector pixel.

In operation 212, the computer 108 adjusts the virtual projector output. The computer 108 applies the calculated projector intensity contributions determined in operation 210 to the virtual projectors in the idealized virtual world. The virtual projector outputs are adjusted according to the specific contributions of each projector to a particular location on the projection surface as calculated in operation 210. For example, for a given pixel, the computer may determine that a first projector (e.g., projector 102) contributes 40% of the light intensity for the pixel and a second projector (e.g., projector 104) contributes 60% of the light intensity for the pixel. The computer 108 adjusts the intensity outputs of each of the virtual projectors so that the intensities of the projectors match the calculated contributions (i.e., projector 102 is adjusted to 40% output and projector 104 is adjusted to 60% output).

In operation 214, the computer 108 calculates and applies physical compensation parameters to the pixel intensity blending maps generated in operation 210. The initial pixel intensity blending maps generated in operation 210 are determined for an idealized virtual world and as such physical phenomena are not directly accounted for in these maps. However, the physical phenomena and “real-world” operating parameters can be adjusted for once the pixel intensity blending maps have been generated. Taking into account these additional characteristics allows the correction applied to the projection system to be more accurate and provide a better output image. Physical parameters include, but are not limited to, surface reflectance of the projection surface 110, including reflectance based on surface geometry and color (hue), light falloff and attenuation from physical blend maps, light intensity, artistic desired intensity, and the projector's internal color response.

In one example, the geometry of the projection surface 110 can be at an angle with respect to the projector 102, and a portion of the light projected by the projector 102 may not be reflected toward the viewer as desired. To compensate for such a situation, the intensity of the pixels incident on the angled portion of the projection surface 110 can be increased to ensure that the perceived intensity of the projected light is consistent with surrounding pixels. This adjustment can be calculated based on the known surface geometry. That is, the further the angle of the projection surface 110 is from normal to the viewer, the more the pixel intensity on the angled region will be increased. Such increases can be experimentally determined, or calculated based on the surface geometry and the measured or approximated reflectance of the projection surface 110. Alternatively, cameras 106 or other imaging devices can measure pixel intensity of a projected image to determine reflectance variation. For example, an image of uniform pixel intensity can be projected onto the projection surface 110. Because of the geometry, certain regions of the projection surface do not reflect the same intensity as others. The camera 106 can detect the variations in reflectance, and the intensity of the projected image can be adjusted to compensate. The light attenuation is compensated for by calculating the distance the light travels from the 3D position of the projector to the surface. It's compensated by adjusting the intensities accordingly such that the same intensity falls onto the surface. Artistic intent is added by adding an additional attenuation intensity mask which is applied on top of the other corrections. A camera image can also be used for adjustments by warping the camera image to the projectors' image planes using projector-to-camera LUTs and changing the projector pixel intensities according to the corresponding intensities of the warped camera image.

As another example, the reflectance of the projection surface 110 may depend on the wavelength of the incident light. Therefore, the intensity of certain colors is increased or decreased in order to produce a smooth and perceptibly consistent projected image. The surface reflectance may be a measurable property of the projection surface material and can be adjusted based on experimentally determined wavelength based reflectance variations. The camera 106 or other imaging device can measure the reflected intensity of different color projections and adjustments to pixel intensity can be made based on the measured variations

Those skilled in the art will appreciate that additional physical adjustments may be required based on a number of physical phenomena and technology specific imperfections. The physical or real world parameters can be taken into account either manually or automatically. For example,

In operation 216, the physical compensation parameters are combined with the pixel intensity blending maps generated in operation 210 to generate final pixel intensity blending maps. A final pixel intensity blending map can be calculated for each of the projector-to-projector pixel maps. In operation, the final pixel intensity blending maps can be provided to the projectors 102, 104 and used to adjust, on a pixel by pixel basis, the intensity of the projected light, so that the projected image appears seamless and consistent in pixel intensity. Optionally, the final pixel intensity blending maps may be dithered in order to avoid banding artifacts when only a limited projector bit depth is available (e.g., an 8-bit projector). Dithering includes approximating colors not in the color space of the projector 102, 104 with a diffusion of colored pixels from within the available color space. For example, if red and blue are part of the color space, but purple is not, then diffusing red and blue pixels can create an image that appears purple. Dithering can be used to avoid perceptible color banding by simulating a wider variety of colors than are actually available in the color space of the projector.

In embodiments where the projectors 102, 104 are projecting low intensity images, such as black projections, pixel intensity cannot be reduced below a certain value because projectors are often associated with a certain level of light leakage, due to hardware and/or software limitations. In such embodiments, rather than reducing pixel intensity in overlapping regions according to a pixel intensity blending map (or in addition to), as described above with respect to FIG. 2, the light intensity may be increased in non-overlapping regions in order to create a perceptibly smooth intensity between overlapping and non-overlapping regions. That is, the overall contrast of the projected image is reduced in order to generate a perceptibly smooth image without any noticeable hard edges created by aggregate light leakage. Without such an adjustment, the overlapping regions receive more aggregate light leakage than the non-overlapping regions because multiple projectors are contributing light leakage to the overlapping regions.

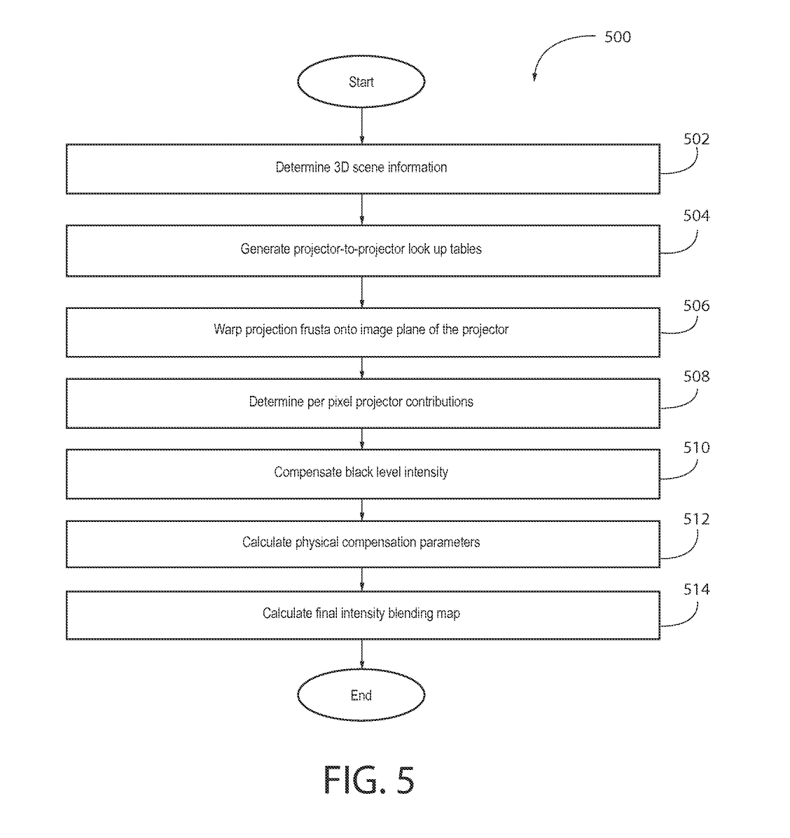

FIG. 5 is a flowchart illustrating a method 500 of generating a black level intensity blending map. The operations of the method 500 can be performed, in whole or in part, by the computer 108 of FIG. 1. However, other devices or components can perform some or all of the operations of the method 500 according to various alternative embodiments. In multiple projector systems, such as that shown in FIG. 1, the intensity of light in overlapping regions is the aggregate of the contributions of each of the projectors projecting to the overlapping region. When projecting a black image, most if not all traditional projectors are unable to project zero light, because some light leaks out of the projector. Light from the light source of the projector system can escape through the lens of the projector or around any physical projector mask and reach the projection surface, even when the light source is supposed to be projecting no light (as in a black projection image). In overlapping regions, the light leakage from one projector aggregates with light leakage from other contributing projectors, leading to visible regions of differing intensity in a field that is intended to be uniform. The intensity of the overlapping regions cannot be reduced using traditional methods because the light leakage is a physical limitation of the projector. The method 500 enables the non-overlapping regions to be adjusted to compensate for the overlapping regions to provide a perceptibly uniform projection image.

In operation 502, the computer 108 (i.e., a processor of the computer 108) determines the 3D scene information. In various embodiments, the 3D scene information can be determined as described above with respect to operation 202 of the method 200. Specifically, the 3D scene information can include the spatial orientation of the projectors 102, 104 and the camera 106 and the surface geometry of the projection surface 110. The orientation of the projectors in space can be manually measured or can be determined by calibrating the camera 106 with the projectors 102, 104. Structured light patterns can be used to determine the 3D geometry of the projection surface 110.

In operation 504, the computer 108 generates projector-to-projector lookup tables. The projector-to-projector lookup tables can be produced as described above with respect to operation 204 of the method 200. Specifically, the projector-to-projector look up tables can be generated by creating and comparing the projector-to-camera look up tables and/or the camera-to-projector look up tables for two projectors (e.g., projectors 102, 104) to one another to determine which pixels of the camera 106 correspond to both of the projectors 102, 104. In operation 506, the computer 108 warps the projection frusta for each projector-to-projector look up table onto the image plane of each projector to generate an initial black level pixel intensity blending map. Operation 506 can be performed as described above with respect to operation 206 of the method 200. Specifically, the projector-to-projector lookup tables can be analyzed for each projector combination in order to generate an initial black level intensity blending map which indicates each pixel of a first projector that is also projected to by a second projector. Additionally, the initial black level intensity blending maps show regions that are not overlapping. The pixel intensity in the non-overlapping regions can be increased to match the pixel intensity in the overlapping regions caused by aggregate light leakage.

In operation 508, the computer 108 determines per pixel projector contributions. The computer 108 analyzes each pixel on the projection surface, and, by referencing the projector-to-projector look up tables, the computer 108 determines the number of projectors projecting to a particular pixel on the projection surface 110. For example, a first overlapping region can have two contributing projectors projecting light in the region. In this example, each pixel in the overlapping region has two contributing projectors. Generally, any number of projectors may contribute pixel intensity to an overlapping region. However, each non-overlapping region only has one contributing projector. For each region on the projection surface the total number of contributing projectors can be determined. The computer 108 can also identify a maximum projection region that has the greatest number of contributing projectors. The maximum projection region can be used to set a target intensity for each of the other projection regions. The pixel intensities in the other projection regions can be adjusted to match the intensity of the maximum projection region. For example, if the maximum projection region has three contributing projectors, then a projection region with two contributing projectors can have the intensity of each of the contributing projectors increased by 50%. Similarly, a projection region with only one contributing projector can have its pixel intensity increased by 200%. The computer 108 can also determine a baseline light leakage level for each projector in non-overlapping regions. For example, the camera 106 can capture an image of the projection surface with a single projector (e.g., projector 102) projecting at its lowest intensity. Because of light leakage, the projected intensity will not be exactly zero, and the camera 106 can determine the minimum intensity for that projector. The process may be repeated for each projector in the multiple projector system to establish a baseline minimum intensity for each projector.

In operation 510, the computer 108 compensates the black level intensity for each projection region in the initial black level pixel intensity blending maps. In one example, the light intensity for each region of the initial black level pixel intensity blending maps can be adjusted (e.g., increased in intensity) such that each region on the projection surface 110 matches the intensity in the overlapping region with the greatest number of contributing projectors. With reference again to FIGS. 4A and B, the pixel 412 is in the overlapping region 410, and has two contributing projectors (i.e., one for each of projection regions 402 and 404). Each of the non-overlapping regions 406 and 408 includes a pixel 416 and 414, respectively. According to operation 510, the black level intensities of the pixels 414 and 416 in the non-overlapping regions 406 and 408 are increased (i.e., made brighter) such that the black level intensities of the pixels 414 and 416 are substantially the same as the aggregate black level intensity of the pixel 412 in the overlapping region 410. Increasing the black level intensity can include, for example, projecting a dark gray, or other near zero intensity pattern to increase the intensity provided to the projections regions with less aggregate light leakage.

In operation 512, the computer 108 calculates physical compensation parameters. The physical parameters can be calculated as described above with respect to operation 212 of method 200. More specifically, the physical parameters that require additional adjustment may include surface reflectance, including reflectance based on the projection surface geometry and color, light falloff and attenuation from physical blend maps, light intensity, and the projector's internal color response. These physical phenomena can be adjusted for by measuring variations in, for example, reflectance, attenuation, and the projector's internal color response. Once measurements are made, adjustments to the black level pixel intensity blending maps are made to compensate for the measured physical phenomena. In operation 514, the computer 108 calculates final black level intensity blending maps. The final black level intensity maps account for light leakage in overlapping projection regions by increasing the light intensity in non-overlapping regions, as well as accounting for various physical parameters which can distort or otherwise affect black level intensities. The computer 108 can apply the final black level pixel intensity maps to each projector in order to compensate for apparent black level discrepancies between overlapping and non-overlapping regions.

FIG. 6 is a block diagram illustrating various operations of the methods of FIGS. 2 and 5 for creating compensation images in a multiple projector system taking into account overlapping intensity compensation and light leakage compensation. Projector-to-projector lookup tables and virtual pixel masks are used to generate a plurality of overlap maps illustrating the overlapping regions of each projector with another projector in the system or itself, as described above with respect to operations 206 and 506 of FIGS. 2 and 5, respectively. In the depicted example, a set of four overlap maps are shown corresponding to one projector of a four projector system. One of the overlap maps corresponds to a projector overlapping with itself (i.e., an identity overlap map in which each pixel to which the projector projects is shown as an overlapping pixel), while the other three overlap maps correspond to a projector projecting to pixels on a projection surface to which another projector in the projection system also projects. In the depicted embodiment, white regions depict pixels that overlap with another projection region, while black regions indicate non-overlapping pixels.

From the overlap maps, a distance estimation can be calculated for each pixel in an overlapping region, as described in operation 208 of FIG. 2. Notably, the distance estimation is only used for the alpha blending maps because the overlapping regions are adjusted in the alpha blending maps while the non-overlapping regions are adjusted for the beta blending maps. Based on the distance estimations and the overlap maps, initial alpha blending maps and beta blending maps are calculated for the virtual representation of the projection system, as described above with respect to operations 210 and 508 of FIGS. 2 and 5, respectively. The initial alpha blending map is generated by applying any necessary blending function to the overlap map using the calculated distance estimation. The initial beta blending map is generated by calculating the black level intensity variations, identifying the maximum projection region, and adjusting the pixel intensities of the other projection regions to match the maximum projection region. However, the initial alpha and beta blending maps are generated for a virtual world and do not account for physical phenomena that may occur in a real world projection system. Therefore, various physical parameters and phenomena are accounted for to create final alpha and beta blending maps which account for projector overlap as well as effects of real-world phenomena, as described in operations 212 and 512. Optionally, the final alpha and beta blend maps can be dithered in order to prevent color banding resulting from limited projector bit depth, as described in operations 214 and 514.

Generating both alpha and beta blending maps, and applying both to projected images can generate a perceptibly smooth and seamless image. By simultaneously reducing pixel intensity in overlapping regions to compensate for aggregate pixel intensity and increasing pixel intensity in non-overlapping regions (and overlapping regions that have fewer contributing projectors than the maximum overlapping region) to compensate for aggregate light leakage, hard seams and other visually distracting effects can be reduced or eliminated from a composite image.

FIGS. 6 and 7 describe exemplary components of the projectors 102, 104, 120 and the computer 108, respectively. With reference to FIG. 6, the projectors 102, 104, 120 may each include one or more processing elements 702, one or more memory components 704, a lens 706, a light source 708, an input/output interface 710, and/or a power source 712. Each of the components of the projectors 102, 104 will be discussed in more detail below.

The processing elements 702 can be substantially any electronic device capable of processing, receiving, and/or transmitting instructions. The memory 704 stores electronic data that are used by the projectors 102, 104, 120. The input/output interface 710 provides communication to and from the projectors 102, 104, 120, the camera 106, and/or the computer 108, as well as other devices. The input/output interface 710 can include one or more input buttons, a communication interface, such as Wi-Fi, Ethernet, or the like, as well as other communication components such as universal serial bus (USB) cables, or the like. The power source 712 may be a battery, power cord, or other element configured to transmit power to the components of the projectors.

The light source 708 is any type of light emitting element, such as, but not limited to, one or more light emitting diodes (LED), incandescent bulbs, halogen lights, lasers, or the like. The lens 706 is in optical communication with the light source and directs, focuses, and transmits light from the source 708 to a desired destination, in this case, the projection surface 110. The lens 706 varies one more parameters to affect the light, such as focusing the light at a particular distance. The lens may also include or have placed over it one or more physical masks which may block or obscure some or all of the projected light. In some instances, such as when the projector is a laser projector, the lens may be omitted.

The projectors 102, 104, 120 may also include a white balance adjustment or other color balance feature that can be adjusted automatically and/or manually. This allows the white point of the projector to be applied so as to avoid color shifts that are visible by a human observer.

With reference to FIG. 7, a block diagram of components of computer 108, in accordance with the embodiment of FIG. 1 is shown. It should be appreciated that FIG. 7 provides only an illustration of one implementation and does not imply any limitations with regard to the environments in which different embodiments may be implemented. Many modifications to the depicted environment may be made.

Computer 108 includes communications fabric 802, which provides communications between computer processor(s) 804, memory 806, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 814 and cache memory 816. In general, memory 806 can include any suitable volatile or non-volatile computer-readable storage media.

Various embodiments of the present invention can include computer program instructions for generating and applying pixel intensity blending maps in multiple projector systems. The computer program instructions can be stored in persistent storage 808 for execution by one or more of the respective computer processors 804 via one or more memories of memory 806. In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 810, in these examples, provides for communications with other data processing systems or devices, for example, the projectors 102, 104 and the camera 106. In these examples, communications unit 810 includes one or more network interface cards and one or more near field communication devices. Communications unit 810 may provide communications through the use of either or both physical and wireless communications links. Computer programs and processes may be downloaded to persistent storage 808 through communications unit 810.

I/O interface(s) 812 allows for input and output of data with other devices that may be connected to computer 108. For example, I/O interface 812 may provide a connection to external devices 818 such as a keyboard, keypad, a touch screen, a camera, and/or some other suitable input device. External devices 818 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 808 via I/O interface(s) 812. I/O interface(s) 812 may also connect to a display 820.

Display 820 provides a mechanism to display data to a user and may be, for example, an embedded display screen or touch screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of blending pixel intensity comprising:
generating, by a processor, a plurality of pixel maps for a plurality of projectors based on at least one of an orientation of the plurality of projectors and a projection surface; and
adjusting, by the processor, an intensity of at least one pixel of at least one of the plurality of projectors based, at least in part, on the plurality of pixel maps.

2. The method of claim 1, wherein the projection surface has a three-dimensional geometry.

3. The method of claim 1, further comprising:
determining, by the processor, one or more overlapping projection regions based, at least in part, on the plurality of pixel maps.

4. The method of claim 3, further comprising:
determining, by the processor, a pixel intensity blending function for the overlapping projection regions; wherein
adjusting the intensity of at least one pixel is based, at least in part, on the pixel intensity blending function.

5. The method of claim 4, wherein adjusting the intensity of at least one pixel comprises decreasing a projected light intensity for one or more projectors of the plurality of projectors.

6. The method of claim 4, wherein adjusting the intensity of at least one pixel comprises increasing a projected light intensity for one or more projectors of the plurality of projectors.

7. The method of claim 1, further comprising:
determining, by the processor, one or more overlapping projection regions and one or more non-overlapping projection regions; and
determining, by a processor, a maximum overlapping projection region having a maximum pixel intensity; wherein
adjusting the intensity of at least one pixel comprises increasing an intensity in the non-overlapping regions to match an intensity of the maximum overlapping projection region.

8. The method of claim 1, wherein generating the plurality of pixel maps comprises:
receiving, by the processor, data corresponding to an image of a structured light pattern projected by the plurality of projectors onto the projection surface;
mapping, by the processor, each pixel of the camera to each pixel of each projector to generate a plurality of projector-to-camera look up tables; and
mapping, by the processor, each pixel of each projector to each pixel of other projectors in the plurality of projectors to generate a plurality of projector-to-projector look up tables.

9. The method of claim 1, further comprising further adjusting by the processor, the intensity of the at least one pixel based on at least one of physical characteristics of at least one of the projector, geometry of the projector relative to the projection surface, or the projection surface.

10. The method of claim 9, wherein the at least one physical characteristic includes a light distance between the projector and the projection surface, a diffusion characteristic of the projection surface, a projection angle, a surface reflection from the projection surface, or an internal color response of the projector.

11. A method of generating a substantially seamless image with a plurality of overlapping projection images, comprising:
projecting, with a first projector, a first structured light pattern on a projection surface;
receiving, by a processor, a first image corresponding to the first structured light pattern;
projecting, with a second projector, a second structured light pattern on the projection surface, wherein the second structured light pattern at least partially overlaps the first structured light pattern on the projection surface;
receiving, by the processor, a second image corresponding to the second structured light pattern;
generating, by the processor, a set of pixel correspondences between the first projector and second projector, based on the first image and the second image; and
modifying a brightness of one or more pixels of at least one of the first and second projector based, at least in part, on the set of pixel correspondences.

12. The method of claim 11, further comprising:
identifying, by the processor, one or more projection regions where the first projector and the second projector overlap; and
determine a blending function for the one or more projection regions.

13. The method of claim 11, wherein the brightness of the one or more pixels is modified based on a distance between the pixel and an edge of the one or more projection regions.

14. The method of claim 11, further comprising:
identifying, by the processor, an overlapping projection region and a non-overlapping projection region on the projection surface; and
determining, by a processor, a maximum pixel intensity in the overlapping region; wherein
modifying the brightness of one or more pixels comprises selectively increasing a brightness of one or more pixels in the non-overlapping regions.

15. The method of claim 11, further comprising:
storing, by the processor, the set of pixel correspondences as a plurality of look up tables.

16. The method of claim 15, further comprising:
generating, by the processor, a plurality of overlap maps based on the plurality of look up tables.

17. The method of claim 16 further comprising:
determining, by the processor, a distance estimation for a plurality of pixels in an overlapping region on the projection surface; wherein
modifying the brightness of the one or more pixels is based, at least in part, on the distance estimation.

18. A system for generating pixel intensity blending maps comprising a plurality of projectors for projecting at least partially overlapping projection regions on a projection surface;
a processor; and
a computer readable storage device having program instructions stored thereon for execution by the processor, the program instructions comprising:
program instructions to project, by the plurality of projectors, structured light patterns on the projection surface;
program instructions to receive data corresponding to images of the structured light patterns;
program instructions to generate a plurality of pixel maps for each of the plurality of the projectors, the pixel maps including overlapping projection region information; and
program instructions to adjust an intensity of one or more pixels based on the pixel maps to generate a composite image having a perceptibly smooth intensity.

19. The system of claim 18, wherein the program instructions further comprise:
program instructions to reconstruct a surface geometry of the projection surface based on the images of the structured light patterns.

20. The system of claim 19, wherein the program instructions further comprise:
program instructions to convert the captured images to an image plane of the each of the plurality of projectors based on the surface geometry of the projection surface.

21. The system of claim 18, wherein the overlapping projection region information includes pixel identification for at least one overlapping projection region and at least one non-overlapping projection region.

22. The system of claim 21, wherein the program instructions to adjust the intensity of one or more pixels comprise:
program instructions to decrease a light intensity of at least one projector that projects onto the overlapping projection region.

23. The system of claim 21, wherein the program instructions to adjust the intensity of one or more pixels comprise:
program instructions to increase a light intensity of at a projector of the plurality of projectors that projects onto the non-overlapping region.
